(19) United States
(12) Patent Application Publication
(10) Pub. No.: US 2019/0202548 A1
(43) Pub. Date: Jul. 4, 2019

(54) FLOW ACTUATOR MODULE AND FLOW BODY SYSTEM

(71) Applicant: AIRBUS DEFENCE AND SPACE GMBH, Taufkirchen (DE)

(72) Inventors: Philipp SCHLOESSER, Munich (DE); Stefan STORM, Unterschleissheim (DE); Markus CHRISTMANN, Munich (DE)

(21) Appl. No.: 16/229,961

(22) Filed: Dec. 21, 2018

(30) Foreign Application Priority Data
Dec. 29, 2017 (DE) 10 2017 223 882.8

(51) Int. Cl. B64C 23/00

(52) U.S. Cl. CPC B64C 23/005

(57) ABSTRACT

A flow actuator module having a support device, a flow actuator mounted on the support device to be movable between a retracted position and a deployed position and which has an actuation portion and a flow plate rigidly connected to the actuation portion, an electrical coil arranged on the support device, and an armature on the actuation portion of the flow actuator and which has a magnetizable metal material. The flow actuator, in the retracted position, can be fixed in a positionally static manner relative to the support device by the armature by generation of an electrical current flow through the coil. A flow body system having a flow actuator module of the type, and an aircraft, are also disclosed.

### CROSS-REFERENCE TO RELATED APPLICATION

This application claims priority to German Patent Application No. 10 2017 223 882.8 filed Dec. 29, 2017, the entire disclosure of which is incorporated by reference herein.

### TECHNICAL FIELD

The disclosure herein relates to a flow actuator module and flow body system, in particular for an aircraft, and to an aircraft.

### BACKGROUND

Although usable in a wide variety of applications of flowed-around surfaces, the disclosure herein and the problem on which it is based will be discussed in more detail with regard to flowed-around surfaces of aircraft.

To realize a flow body with low flow resistance and large lift forces, it is often sought to influence a fluid flow flowing around the flow body such that a flow separation is as far as possible prevented. Normally, for this purpose, vortex systems are introduced into the fluid flow in targeted fashion at a flowed-around surface of the flow body. This serves for energizing the boundary layer, with the aim of preventing a separation of the flow and realizing an expedient pressure distribution along the surface, with improved lift and reduced flow resistance of the flow body.

Flow bodies of aircraft, such as for example wings, vertical tail unit, horizontal tail units, flow flaps or the like, are subjected to different incident flow conditions during the operation of an aircraft. For example, greater incident flow angles arise at the wings during takeoff and landing of the aircraft than during cruising flight. A large deflection of the vertical rudder is necessary for example if, during takeoff, one engine fails or generates only little thrust and it is necessary to counter-steer using the vertical rudder in order to keep the aircraft on course. There is therefore a demand to be able to influence the fluid flow in targeted fashion through the introduction of vortex structures depending on the incident flow situation.

To generate the vortex structures, use is normally made of flow actuators. DE 10 2015 101 765 A1 describes a system having flow actuators which, when required, can be pivoted out relative to the flowed-over surface of the flow body. Here, the flow actuators are mechanically preloaded by a spring, and are held in a pivoted-in position by a holding device. When required, the flow actuator is released from the holding device by a triggering device, and is pivoted by the preload force of the spring into a pivoted-out position, in which the flow actuator protrudes relative to the surface of the flow body. A similar system is described in U.S. Pat. No. 6,837,465 B2, wherein the flow actuator is pivoted out by a pneumatic actuation element.

### SUMMARY

It is an object of the disclosure herein to provide a flow actuator module which operates reliably and with a high level of fail-safety.

This object is achieved in each case by features disclosed herein.

Advantageous embodiments and refinements are also disclosed herein.

According to a first aspect of the disclosure herein, a flow actuator module having a support device, a flow actuator, an electrical coil and an armature is provided.

The flow actuator is mounted on the support device so as to be movable, preferably pivotable, between a retracted position and a deployed position, and has an actuation portion and a flow plate rigidly connected to the actuation portion. The actuation portion is accordingly formed so as to be positionally static relative to the flow plate. The flow plate is provided for forming a flow obstruction when the flow actuator is arranged in the deployed position relative to the support device.

The electrical coil is arranged on, in particular fastened to, the support device. The armature is arranged on or fastened to the actuation portion of the flow actuator and is formed from a magnetizable metal material, for example iron. The flow actuator, in the retracted position, can be fixed in a positionally static manner relative to the support device by the armature by generation of an electrical current flow through the coil. The coil accordingly forms an electromagnet which, in an activated state, that is to say when current flows through the coil, exerts a magnetic attracting force on the armature arranged on the flow actuator. In this way, the flow actuator is held in the retracted position when current flows through the coil. If the current flow through the coil is interrupted, for example as a result of separation of the coil from a voltage source, magnetic force is no longer exerted on the armature, and a movement or pivoting of the flow actuator into the deployed position is permitted. Accordingly, no electrical energy is required for moving or pivoting the flow actuator into the deployed position. In the event of a disruption or interruption of the current supply, the flow actuator module thus remains automatically usable, or is automatically movable into the deployed position. This increases the reliability of the system. Furthermore, mechanical actuation or locking elements are not imperatively required. In this way, the susceptibility of the module to wear or aging is reduced.

In one embodiment, the flow actuator is mounted on the support device so as to be pivotable about an axis of rotation. Accordingly, a mounting with a bearing device is provided, which defines an axis of rotation about which the flow actuator is pivotable. The axis of rotation may be defined in particular by a rotary bearing or by a guide rail or a guide rail arrangement. An axis of rotation is thus to be understood to mean a central point of a circular path along which the flow actuator is moved.

In one embodiment, the flow plate of the flow actuator has a first surface provided for arrangement in alignment with a flow surface of a flow body in the retracted position of the flow actuator, and has a second surface situated opposite the first surface. The second surface of the flow plate faces toward the actuation portion. Here, the axis of rotation is arranged on a rear side of the flow plate, the rear side being defined by the second surface of the flow plate. Accordingly, in the retracted position of the flow actuator, the axis of rotation is arranged below an outer surface of the flow plate. Since the outer surface of the flow plate is provided for arrangement in alignment with a flow surface of a flow body in the retracted position of the flow actuator, the axis of rotation lies below the flow surface of the flow body in the retracted position of the flow actuator. In this way, the air resistance of the flow actuator module when it is arranged in the retracted position is advantageously reduced, in particular is reduced such that the flow actuator module does not influence the air resistance of the flow body.

In a further embodiment of the flow actuator module, provision is made for the actuation portion to be of plate-like form and to extend at an angle relative to the flow plate. In this embodiment, a flow plate and an actuation plate are thus provided, which together form an angle and preferably enclose an acute angle between them. The design of the actuation portion as a plate offers the advantage that the actuation portion can on the one hand be utilized as a stop for abutment against a wall of a flow body in the deployed position of the flow actuator and can additionally be utilized for covering a recess of the flow surface, in which the flow plate is arranged in the retracted position of the flow actuator. In this way, in particular, the risk of instances of contamination within the flow body, and the risk of contamination of the flow actuator module itself, is reduced.

Provision is optionally made for the actuation portion to have a first surface facing toward the flow plate, in particular facing toward the second surface of the flow plate, and for the axis of rotation to be arranged on a rear side of the actuation portion, the rear side being situated opposite the first surface of the actuation portion. Thus, in this embodiment, even in the deployed position of the flow actuator, the axis of rotation is arranged below the flow surface of the flow body, whereby the air resistance is further reduced.

In a further embodiment, the flow plate is formed with a triangular periphery. Accordingly, a peripheral edge of the flow plate forms a triangular shape. By the triangular design, it is possible with a simple structural design to generate turbulence in a fluid flow in an efficient manner.

In particular, provision may be made for a first limb of the periphery of the flow plate to extend along the optional axis of rotation, and for a second and a third limb to converge on one another with increasing distance from the axis of rotation. Descriptively speaking, the second and the third limb form a tip of the triangular shape, whereas the base of the triangular shape extends along the axis of rotation. To generate turbulence in a fluid flow in the deployed position of the flow actuator, the flow actuator is preferably arranged such that the tip of the triangular shape is situated upstream of the axis of rotation.

In a further embodiment, the actuation portion and the flow plate are connected by a connection plate which extends between them.

The connection plate extends preferably along the optional axis of rotation, and is curved about the axis of rotation. The connection plate may thus in particular be formed as a cylinder segment which extends along the axis of rotation. A radius of curvature of the connection plate preferably corresponds to a spacing between the axis of rotation and the connection plate. By the curved shape, a gap between the recess of the flow surface, in which the flow plate is arranged in the retracted position, and the connection plate during the pivoting of the flow actuator can be reduced in size. This additionally reduces the risk of contamination.

In a further embodiment, the flow actuator module additionally has a preload device which is arranged between the support device and the flow actuator and which, in the retracted position of the flow actuator, preloads the latter relative to the support device in the direction of the deployed position. Thus, in the retracted position, the preload device subjects the flow actuator to a force directed away from the support device. This advantageously assists the pivoting into the deployed position when the coil is switched into an electrically deenergized state. The preload device may for example be realized as a spring, in particular a spiral or bow spring, as a magnet device or the like.

In a further embodiment, the flow actuator module additionally has a return device which is coupled to the support device and which has a drive and an actuation element, wherein the actuation element is coupled to the flow actuator so as to be movable relative to the support device by the drive. The actuation element may for example be in the form of a threaded spindle. The actuation element is preferably coupled to the flow actuator by an elastically deformable coupling element, for example the preload device. By the return device, an automatic pivoting of the flow actuator module back into the retracted position, for example after an electrical deenergization of the coil for test purposes, is facilitated.

In a further embodiment, the flow actuator module additionally has a base plate which is fastened to the support device and which has a recess, wherein, in its retracted position, the flow plate is arranged in the recess of the base plate and a first surface of the flow plate is arranged in alignment with an outer surface of the base plate, and wherein, in its deployed position, the flow plate protrudes relative to the outer surface of the base plate. The first surface of the base plate thus forms a part of a flow surface of a flow body. In the retracted position, the first surface of the flow plate likewise forms a part of the flow surface. The base plate facilitates the retrofitting of the flow actuator module onto a flow body.

Provision may furthermore be made whereby the actuation portion of the flow actuator, in the deployed position, bears against an inner surface of the base plate, the inner surface being situated opposite the outer surface. The actuation portion thus has a stop region or forms a stop, whereby the distance covered between the retracted position and the deployed position of the flow actuator is defined.

Provision may optionally be made here for the actuation portion to cover the recess of the base plate. For this purpose, the actuation portion may for example be of plate-like form, as has been described above.

According to a further aspect of the disclosure herein, a flow body system is provided, in particular a flow body system for an aircraft. The flow body system has a flow body and a flow actuator module according to one of the embodiments described above.

The flow body comprises a flow surface for being flowed over by a fluid flow, and with an inner surface situated opposite the flow surface, wherein the flow body has a recess which extends between the flow surface and the inner surface. The flow surface may in particular have a planar or a curved extent.

The support device of the flow actuator module is arranged in an interior space of the flow body, the interior space being defined by the inner surface of the flow body. In the retracted position, the flow plate of the flow actuator module is arranged in the recess of the flow body and a first surface of the flow plate is arranged in alignment with the flow surface of the flow body. The flow actuator can be fixed in a positionally static manner relative to the support device by the armature by generation of an electrical current flow through the coil.

The flow surface of the flow body may in particular be situated on the suction side of the flow body or form a suction side of the flow body.

According to a further aspect of the disclosure herein, an aircraft having a flow body system as described above and having an electrical voltage source which is electrically connectable by a switching device to the coil of the flow actuator module is provided. The switching device is in particular designed for producing and interrupting an electrical connection between the coil and the voltage source. In an “on” state of the switching device, in which the switching device produces an electrical connection between the voltage source and the coil, the coil is flowed through by an electrical current which induces a magnetic field around the coil. In this way, the magnetizable armature is attracted by the coil, and the flow actuator is thus held in its retracted position. In an “off” state of the switching device, in which the switching device interrupts an electrical connection between the voltage source and the coil, the coil is not flowed through by an electrical current, and there is consequently no magnetic field around the coil. As a result, the flow actuator is released, and is movable or possibly pivotable into the deployed position.

In one embodiment, the flow body of the flow body system is formed by a vertical tail unit of the aircraft. The flow actuator module is preferably arranged between a leading edge and an aerodynamic control surface of the vertical tail unit. With the flow actuator module, by movement of the flow actuator into the deployed position, a flow separation can be impeded or even prevented in an efficient manner. This has the effect that the aerodynamic control surface is acted on with a greater force by the fluid flow. Alternatively, the control surface, while being acted on with a given force, can be dimensioned to be smaller. Weight can be saved in this way. At the same time, the flow resistance of the vertical tail unit is reduced overall.

In a further embodiment of the aircraft, the switching device has a current converter for applying an alternating current to the coil. Accordingly, the switching device is designed such that a current converter can be activated, which converts an electrical direct-current voltage of the voltage source into an alternating-current voltage. As a result, an alternating current flows in the coil, and a magnetic field which varies over time is consequently induced. This leads to the induction of eddy currents in the armature, whereby the latter is repelled by the coil. In this way, the pivoting of the flow actuator into the deployed position is further facilitated.

With regard to directional references and axes, in particular to directional references and axes relating to the profile of physical structures, a profile of an axis, of a direction or of a structure “along” another axis, direction or structure is to be understood to mean that these, in particular the tangents which arise in particular at a respective point of the structures, run in each case at an angle of less than 45 degrees, preferably less than 30 degrees, and particularly preferably parallel, with respect to one another.

With regard to directional references and axes, in particular to directional references and axes relating to the profile of physical structures, a profile of an axis, of a direction or of a structure “transversely” with respect to another axis, direction or structure is to be understood to mean that these, in particular the tangents which arise at a respective point of the structures, run in each case at an angle of greater than or equal to 45 degrees, preferably greater than 60 degrees, and particularly preferably perpendicular, with respect to one another.

### BRIEF DESCRIPTION OF THE DRAWINGS

The disclosure herein will be discussed below with reference to the figures of the example drawings. In the figures:

FIG. 1 shows a schematic sectional view of a flow body system according to an exemplary embodiment of the disclosure herein, wherein a flow actuator of a flow actuator module of the flow body system is arranged in a retracted position;

FIG. 2 shows a schematic sectional view of the flow body system shown in FIG. 1, wherein the flow actuator of the flow actuator module of the flow body system is arranged in a deployed position;

FIG. 3 shows a perspective view of the flow body module according to an exemplary embodiment of the disclosure herein, wherein the flow actuator is arranged in the retracted position;

FIG. 4 shows a perspective sectional view of the flow body module shown in FIG. 3 in a section along the line B-B illustrated in FIG. 3;

FIG. 5 shows a perspective view of the flow body module in FIG. 3, wherein the flow actuator is arranged in the deployed position;

FIG. 6 shows a schematic view of an aircraft according to an exemplary embodiment of the disclosure herein;

FIG. 7 shows a schematic partial view of a flow body system in an aircraft according to a further exemplary embodiment of the disclosure herein; and

FIG. 8 shows a schematic sectional view of a flow body system according to a further exemplary embodiment of the disclosure herein, wherein a flow actuator of a flow actuator module of the flow body system is arranged in a retracted position.

In the figures, the same reference designations are used to denote identical or functionally identical components, unless stated otherwise.

### DETAILED DESCRIPTION

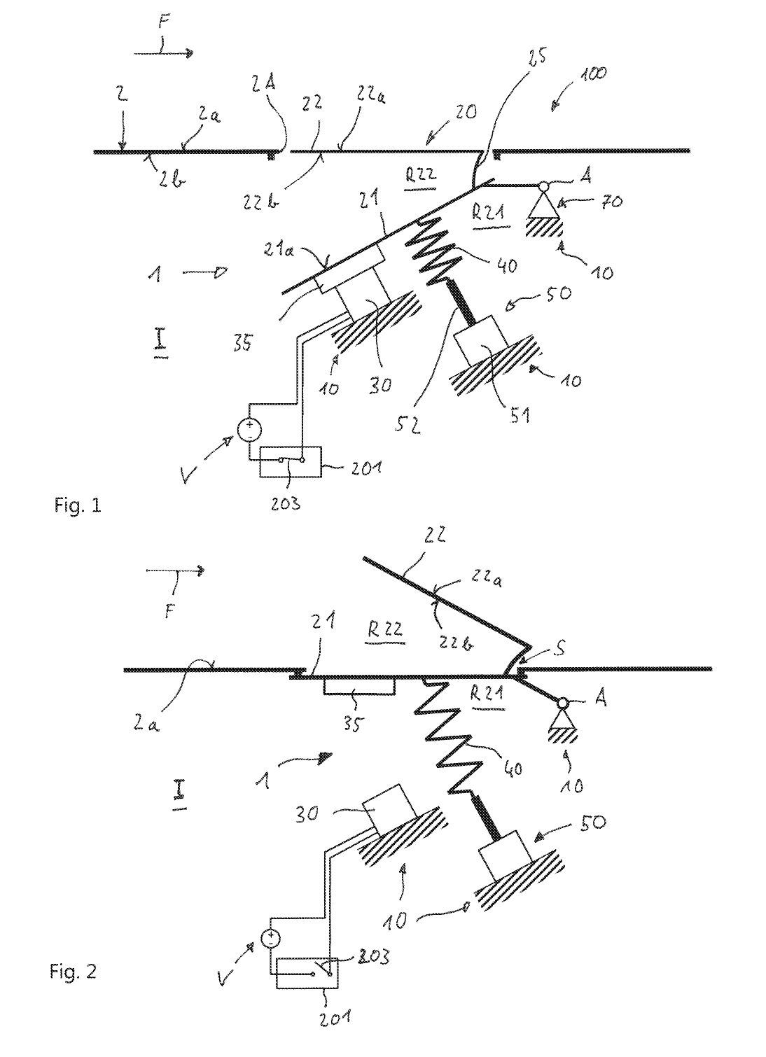

FIG. 1 schematically shows a flow body system 100 in a sectional view. The flow body system 100 has a flow actuator module 1 and a flow body 2. Also illustrated in FIG. 1 are an electrical voltage source V and a switching device 201, which may for example be part of an aircraft 200 in which the flow body system 100 can be used.

The flow body 2 has a flow surface 2a, which is provided for being flowed over by a fluid flow. In FIG. 1, a flow direction in which the fluid flow flows over the flow surface 2a is denoted by the reference designation F. The flow body 2 furthermore has an inner surface 2b situated opposite the flow surface 2a. The inner surface 2b defines an interior space I of the flow body 2. The flow body 2 has a recess 2A which extends between the flow surface 2a and the inner surface 2b, as is schematically illustrated in FIG. 1.

As is schematically illustrated in FIG. 1, the flow actuator module 1 has a support device 10, a flow actuator 20, an electrical coil 30, and an armature 35. A preload device 40 and a return device 50 may each optionally be provided in addition, as is schematically illustrated in FIG. 1.

As is schematically illustrated in FIGS. 1 and 2, the flow actuator 20 has an actuation portion 21 and a flow plate 22. The actuation portion 21 is rigidly connected to the flow plate 22, for example by an optional connection plate 25, as is schematically shown in FIGS. 1 and 2. The actuation portion 21 is thus positionally static relative to the flow plate 22.

In the exemplary flow body system 100 shown schematically in FIGS. 1 and 2, the support device 10 is arranged in the interior space I of the flow body 2, and is positionally static relative to the flow body 2. In particular, the support device 10 may be fastened to the flow body 2.

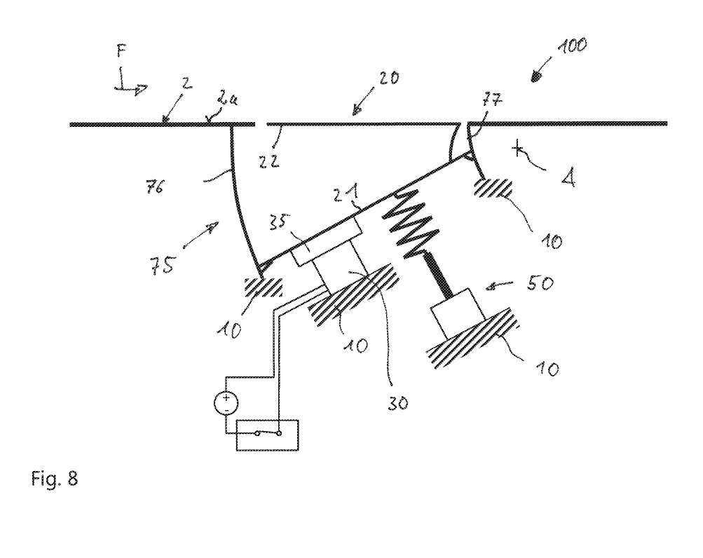

The flow actuator 20 is mounted on the support device 10 so as to be movable between a retracted position and a deployed position. In the flow actuator module 1 shown by way of example in FIGS. 1 and 2, the flow actuator 20 is mounted on the support device 10 so as to be pivotable about an axis of rotation A. For the pivotable mounting, a rotary joint 70 is provided, which is illustrated symbolically in FIG. 1. The rotary joint 70 may be formed in particular by a first joint portion provided on the flow actuator 20 and a second joint portion provided on the support device 10, as will be discussed in more detail below. Alternatively, the axis of rotation A may also be defined by a guide rail arrangement 75, as illustrated by way of example and schematically in FIG. 8. The guide rail arrangement 75 has a first rail 76 and a second rail 77, which each run in the manner of a circular path and are fastened in a positionally static manner to the support device 10. As shown by way of example in FIG. 8, respectively opposite end portions of the actuation portion 21 are guided on the rails 76, 77. Otherwise, the flow actuator module 1 shown in FIG. 8 is of identical construction to the flow actuator module 1 shown in FIGS. 1 and 2.

FIGS. 1 and 8 show the flow actuator 20 in the retracted position. In the retracted position of the flow actuator 20, the flow plate 22 is arranged in the recess 2A of the flow body 2 and a first surface 22a of the flow plate 22 is arranged in alignment with the flow surface 2a of the flow body 2. As can be seen in FIG. 1, the first surface 22a of the flow plate 22 in the retracted position forms a part of, or forms a continuation of, the flow surface 2a of the flow body 2. FIG. 2 shows the deployed position of the flow actuator 2. In the deployed position, the flow actuator 20 has been pivoted relative to the support device 10, or relative to the flow body 2, about the axis of rotation A. In the deployed position, the flow plate 22 protrudes relative to the flow surface 2a of the flow body 2 and thus forms a flow obstruction for the fluid flow, whereby vortex structures are introduced into the fluid flow. This leads to mixing of the boundary layer of the flow with the outer flow, whereby energy is supplied to the boundary layer, which counteracts a separation of the flow. Here, the fluid flow F impinges in particular on a second surface 22b, situated opposite the first surface 22a, of the flow plate 22.

The optional preload device 40 is arranged between the support device 10 and the flow actuator 20. The preload device 40 may be formed for example by a pressure spring, as is symbolically illustrated in FIG. 1. The preload device 40 is kinematically coupled in each case to the flow actuator 20, for example to the actuation portion 21 of the flow actuator 20 as shown by way of example in FIG. 1, and to the support device 10, or is supported against the components. In the retracted position of the flow actuator 20, the preload device 40 subjects the flow actuator 20 to a force directed away from the support device 10. A pivoting of the flow actuator 20 into its deployed position can thus be effected or assisted by the force. The spring shown by way of example in FIG. 1 is compressed in the retracted position. Thus, the preload device 40 preloads the flow actuator 20 relative to the support device 10 in the direction of the deployed position.

The electrical coil 30 is arranged on the support device 10 and is in particular fastened thereto, for example screwed or adhesively bonded thereto. The coil 30 may for example be a cylindrical coil. The electrical coil 30 is connectable to an electrical voltage source V. It is illustrated by way of example in FIG. 1 that the coil is connected, or electrically connected, to the voltage source V. For this purpose, a switching element 203 of a switching device 201 is switched into an “on” state, such that an electrical current flows through the coil 30.

An armature 35 is arranged on or fastened to the actuation portion 21 of the flow actuator 20, for example is adhesively bonded or screwed to the actuation portion 21. As is schematically shown in FIG. 1, the armature 35 is arranged in a region of the actuation portion 21 which is situated opposite the coil 30 in the retracted position of the flow actuator 20. The armature 35 is formed from a magnetizable metal material, for example iron, an alloy based on iron, nickel and/or cobalt, or a similar material.

If an electrical current, in particular a direct current, flows through the coil 30, as is schematically illustrated in FIG. 1, a magnetic field forms around the coil 30. Because of the force action of the magnetic field, the armature 35 is pulled against the coil 30. As a result, the flow actuator 20, in the retracted position, is fixed in a positionally static manner relative to the support device 10, and can thus be fixed in a positionally static manner relative to the support device 10 by the armature 35 by generation of an electrical current flow through the coil 30. If the electrical current flow through the coil 30 is interrupted, for example as a result of the switching element 203 being switched into an “off” position, as is schematically illustrated in FIG. 2, the magnetic field around the coil disappears, and an attracting force no longer acts between armature 35 and coil 30, whereby a pivoting, or generally a movement, of the flow actuator 20 into the deployed position shown by way of example in FIG. 2 is permitted.

The optional return device 50 has a drive 51 and an actuation element 52. As shown by way of example in FIG. 1, the drive 51 is attached to the support device 10. The drive 51 may be realized for example as an electric motor. The actuation element 52 is movable relative to the support device 10 by the drive 51, and is coupled to the flow actuator 20. As shown by way of example in FIG. 1, the actuation element 52 may be coupled to the flow actuator 20 in particular by a spring. This offers the advantage that the spring can simultaneously be utilized as an optional preload device 40. The actuation element 52 may for example be in the form of a threaded spindle.

Below, a method for operating the flow body system 100 will be described by way of example on the basis of FIGS. 1 and 2. The flow surface 2a of the flow body 2 is flowed over by a fluid flow. The flow actuator 20 of the flow actuator module 1 is firstly situated in the retracted position, as shown by way of example in FIG. 1, and is, by the armature 35, fixed in the retracted position by action of an electrical current flow through the coil 30 on the support device 10. At the same time, it is detected whether a triggering criterion for the movement or pivoting of the flow actuator 20 into the deployed state is present. The triggering criterion may be defined for example by a predetermined flow speed of the fluid flow or an operating state of an external component, such as for example an engine of an aircraft. The latter triggering criterion is advantageous in particular if, as shown by way of example in FIG. 6, the flow body system 100 is used on an aircraft 200, and the flow body 2 is formed by a vertical tail unit 202 of the aircraft.

If the triggering criterion is present, the current flow through the coil 30 is interrupted, and the flow actuator 20 is thus released or unlocked. Since the fluid flow flows over the flow surface 2a with a particular flow speed, a pressure difference exists between the interior space I of the flow body 2 and the surroundings, which pressure difference effects a movement or pivoting of the flow actuator 20 into the deployed position, as illustrated by way of example in FIG. 2. The pivoting may advantageously be assisted by the optional preload device 40. Thus, for the unlocking of the flow actuator 20, it is basically possible to dispense entirely with mechanical components which are at risk of wear, in particular with movable components. Since the release of the flow actuator 20 is realized by interruption of the current flow, a triggering is also effected even in the event of an electrical failure.

Alternatively or subsequently to the interruption of the current flow through the coil 30, it is also possible for an alternating current flow through the coil 30 to be generated. For this purpose, the switching device 201 may have a current converter 204 as shown by way of example in FIG. 7. For this purpose, the switching element 203 interrupts a direct supply of current to the coil 30 and connects the current converter 204 in series with the coil 30. A magnetic field which varies over time is thus generated. This leads to the induction of eddy currents in the armature 35, whereby the latter is repelled by the coil 30, as is symbolically illustrated in FIG. 7 by the double arrow X. In this way, the pivoting of the flow actuator 20 into the deployed position is further facilitated.

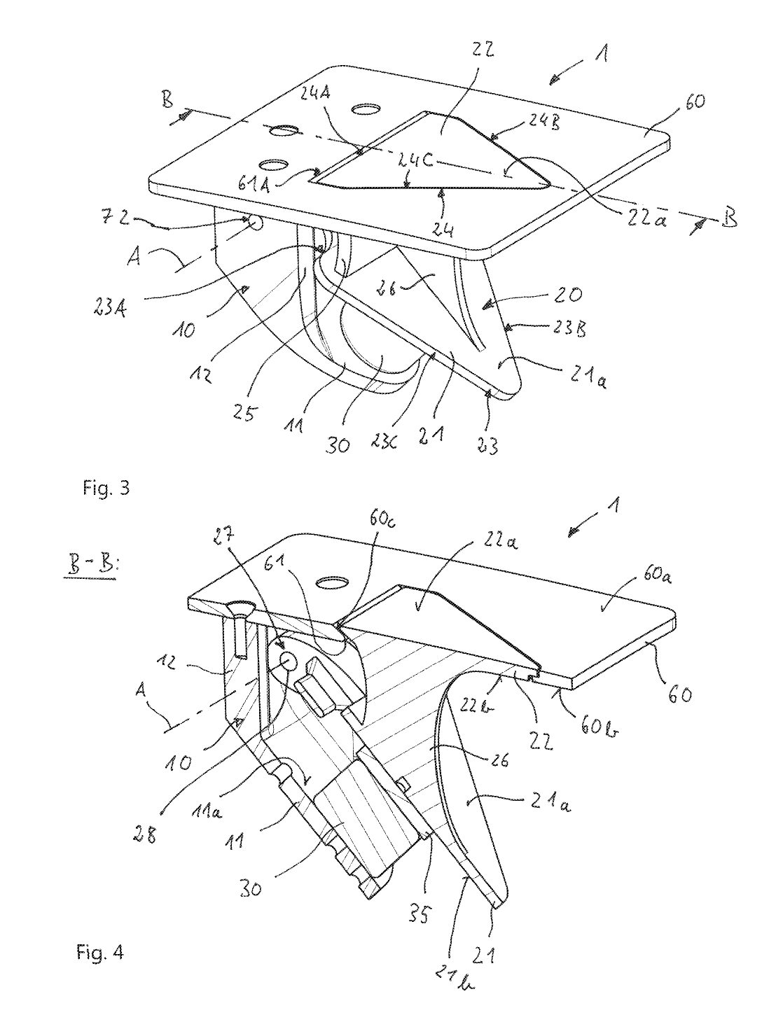

FIGS. 3 through 5 show one possible design of the flow actuator module 1 by way of example. The flow actuator module 1 shown by way of example in FIGS. 3 through 5 has a support device 10, a flow actuator 20, an electrical coil 30, an armature 35 and an optional base plate 60.

The support device 10 has a really extending, plate-like base portion 11 and has a frame portion 12 which protrudes relative to a first surface 11a of the base portion 11 and which extends in U-shaped fashion along a periphery of the base portion 11. The support device 10 may in particular be formed from a metal material, such as for example aluminum or an aluminum alloy.

As already discussed on the basis of FIGS. 1 and 2, the flow actuator 20 comprises an actuation portion 21 and a flow plate 22 connected rigidly to the actuation portion 21. As can be seen in particular in FIG. 3, the flow plate 22 may be formed in particular with a triangular periphery 24. The flow plate 22 has a first surface 22a, which is provided for arrangement in alignment with the flow surface 2a of the flow body 2, or for being flowed over by fluid, in the retracted position of the flow actuator 20. The first surface 22a of the flow plate 22 may be of planar form, as shown by way of example in FIGS. 3 through 5. The first surface 22a of the flow plate 22 may however also have a curved profile, for example in order to form a continuous continuation of a region of a flow surface 2a surrounding the first surface 22a in the retracted position of the flow actuator 20. Furthermore, the flow plate 22 has a second surface 22b situated opposite the first surface 22a.

The actuation portion 21 may in particular likewise be of plate-like form, as illustrated by way of example in FIGS. 3 through 5. Here, the actuation portion 21 has a first surface 21a and a second surface 21b situated opposite the first surface. As shown by way of example in FIGS. 3 through 5, the actuation portion 21 may likewise be formed with a triangular periphery 23.

As shown in FIGS. 3 through 5, the actuation portion 21 and the flow plate 22 are arranged so as to be positionally static relative to one another, wherein the second surface 22b of the flow plate 22 faces toward the first surface 21a of the actuation portion 21. As can be seen in particular in FIG. 4, the actuation portion 21 and the flow plate 22 extend at an angle with respect to one another. In the situation shown by way of example in FIGS. 3 through 5, in which both the flow plate 22 and the actuation portion 21 are each formed with a triangular periphery 24, 23, the limbs 24A, 24B, 24C of the periphery 24 of the flow plate 22 extend in each case along the limb 23A, 23B, 23C of the periphery 23 of the base portion 21.

The actuation portion 21 and the flow plate 22 are rigidly connected to one another. This may be realized for example as in FIGS. 3 through 5 by a connection plate 25 which extends between the actuation portion 21 and the flow plate 22. In FIGS. 3 through 5, there is additionally provided an optional stiffening rib 26 which extends between the actuation portion 21 and the flow plate 22 transversely with respect to the connection plate 25.

The flow actuator 20 is mounted on the support device 10 so as to be pivotable and thus movable about an axis of rotation A. To form a rotary joint 70, a first joint portion 71 is provided on the flow actuator 20, which joint portion may be formed, as shown for example in FIG. 4, as a cam 27 which is formed on the actuation portion 21 and which has a recess 28 defining the axis of rotation A. A second joint portion 72 is formed on the support device 10. As can be seen in FIG. 3, the second joint portion 72 may be formed for example by aligned recesses which are arranged on opposite sides of the frame portion 12 of the support device 10. A bolt 73 serves for the mounting of the first joint portion 71 on the second joint portion 72.

As can be seen in particular in FIG. 3, the axis of rotation A and the optionally triangular flow plate 22 are oriented relative to one another such that a first limb 24A of the periphery 24 of the flow plate 22 extends along the axis of rotation A and a second and a third limb 24B, 24C converge on one another with increasing distance from the axis of rotation A.

The optional connection plate 25 extends preferably along the axis of rotation A, and is preferably curved about the axis of rotation A, as shown by way of example in FIGS. 3 through 5. As is schematically shown in FIG. 2, this offers the advantage that a gap S between the connection plate 25 and the recess 2A or generally between a recess in which the flow plate can be arranged in the retracted state can be kept small over the entire pivoting travel of the flow actuator 20.

As can be seen in particular in FIGS. 1 and 2, the axis of rotation A is arranged preferably on a rear side R22 of the flow plate 22, the rear side being defined by the second surface 22b of the flow plate 22. The axis of rotation A is particularly preferably arranged on a rear side R21 of the actuation portion 21, the rear side being defined by the second surface 21b of the actuation portion 21. As can be clearly seen in particular in FIGS. 1 and 2, it is ensured in this way that the axis of rotation A can be arranged below the flow surface 2a.

As shown in particular in FIG. 4, the coil 30 is arranged on the first surface of the base portion 11 of the support device 10. An optional preload device 40 and an optional return device 50 (neither of which is shown in FIGS. 3 through 5) may likewise be arranged on the first surface of the base portion 11 of the support device 10. The armature 35 is arranged on the second surface 21b of the actuation portion 21 and is positioned there so as to be arranged opposite the coil 30, or so as to at least partially overlap the coil, in the retracted position of the flow actuator 20 as shown in FIGS. 3 and 4.

The optional base plate 60 is formed as an areally extending plate and may in particular have a rectangular periphery, as shown by way of example in FIGS. 3 through 5. The base plate 60 is provided for installation or arrangement in a recess of a flow body 2. The base plate 60 has an outer surface 60a, which preferably extends with a curvature profile, wherein the curvature profile may in particular be formed so as to form a continuous continuation of the region of a flow surface 2a surrounding the periphery of the base plate 60. Furthermore, the base plate 60 has an inner surface 60b situated opposite the outer surface 60a, which inner surface may in particular be of planar form, as shown by way of example in FIG. 4. As is also shown in FIGS. 3 through 5, the base plate 60 has an opening or recess 61 which extends between the outer surface 60a and the inner surface 60b. The recess 61 has a shape corresponding to the periphery 24 of the base plate 22. Therefore, in FIGS. 3 through 5, the recess 61 of the base plate 60 is of triangular design.

The base plate 60 is fastened to the support device 10. In particular, the base plate 60 may be screwed to the frame portion 12 of the support device 10, as shown in particular in FIG. 4, wherein a screw is not illustrated. The base plate 60 is positioned on the support device 10 such that the inner surface 60b of the base plate 60 is oriented so as to face toward the support device 10, in particular toward the first surface 11a of the base portion 11 of the support device 10. The axis of rotation A is situated between the inner surface 60b of the base plate 60 and the base portion 11 of the support device 10.

FIGS. 3 and 4 show the flow actuator 20 in its retracted position. Here, the flow plate 22 is arranged in the recess 61 of the base plate 60 and the first surface 22a of the flow plate 22 is arranged in alignment with the outer surface 60a of the base plate 60. Furthermore, the armature 35 bears against the coil 30. As shown in FIG. 4, the recess 61 of the base plate 60 may form an overlap or abutment region 60c which extends between the outer surface 60a and the inner surface 60b. In the retracted position of the flow actuator 20, the second surface 22b of the flow plate 22 bears against the abutment region 60c of the base plate 60 and thereby covers the recess 61. In this way, a good seal of the recess 61 with respect to a fluid flow flowing over the outer surface 60a of the base plate 60 is realized. This advantageously reduces the risk of contamination of the further components of the flow actuator module 1.

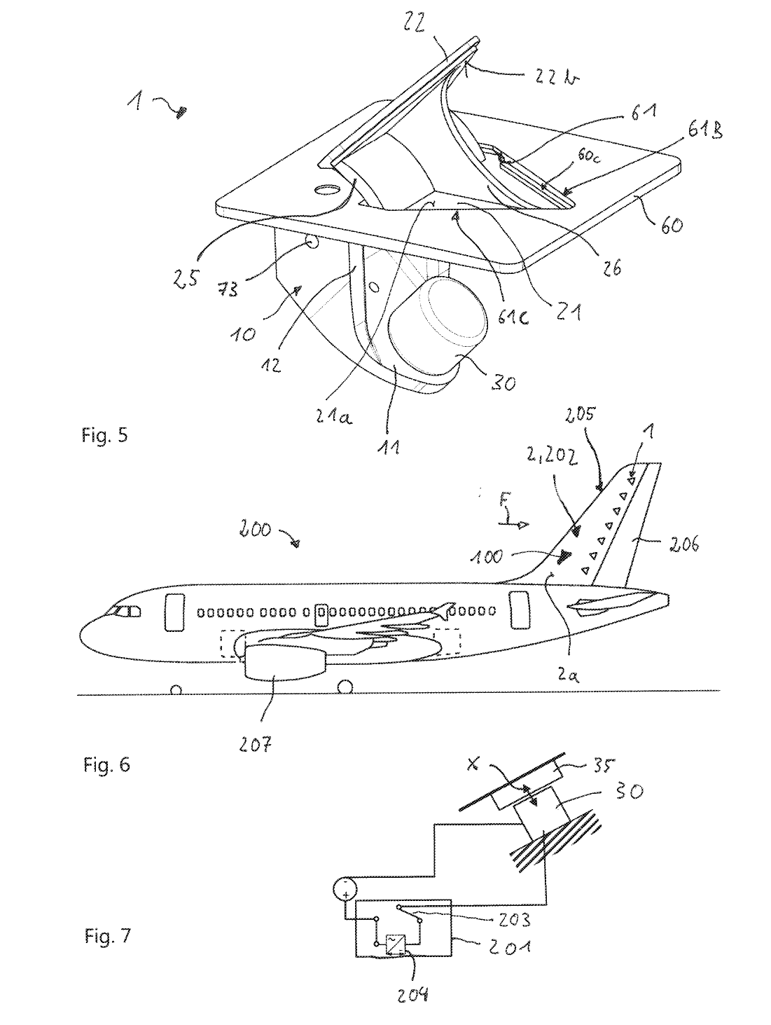

As shown by way of example in FIGS. 3 through 5, the abutment region 60c at a first limb 61A, which extends along the axis of rotation A, of the triangular recess 61 shown by way of example in FIGS. 3 through 5 may be formed as a chamfer or bevel. This can be seen in particular in FIG. 4. At a second and a third limb 61B, 61C of the recess 61, which limbs converge on one another with increasing distance from the axis of rotation A, the abutment region 60c may for example be formed as a step, as can be seen in particular in FIG. 5. The second surface 22b of the flow plate 22 forms, along the first limb 24A of the periphery 24 of the flow plate 22, a bevel which is formed correspondingly to the bevel of the abutment region 60c of the recess 61 of the base plate 60 along the first limb 61A of the recess. Furthermore, the second surface 22b of the flow plate 22 forms, along the second and the third limb 24B, 24C of the periphery 24 of the flow plate 22, a step which is formed correspondingly to the steps of the abutment region 60c of the recess 61 of the base plate 60 along the second and the third limb 61B, 61C of the recess 61.

FIG. 5 shows the flow actuator module 1 in the deployed position of the flow actuator 20. Here, the flow plate 22 protrudes relative to the outer surface 60a of the base plate 60. In particular, the flow plate 22 of the flow actuator 20 extends at an angle or obliquely relative to the base plate 60. As is schematically shown in FIG. 2, the actuation portion 21 of the flow actuator 20 bears against the inner surface 2b of the flow body 2 in the deployed position. If an optional base plate 60 is used, as in FIGS. 3 to 5, the actuation portion 21, in particular the first surface 21a of the actuation portion 21, bears against the inner surface 60b of the base plate 60. It is preferable if, in the deployed position, the actuation portion 21 completely covers the recess 2A of the flow body 2 or the recess 61 of the base plate 60, as illustrated in each of FIGS. 2 and 5. In this way, a reliable seal of the respective recess 2A, 61 is formed also in the deployed position of the flow actuator 20.

FIG. 6 shows, by way of example, an aircraft 200 having the above-described flow body system 100. The flow body 2 of the flow body system 100 is in this case formed by way of example by a vertical tail unit 202 of the aircraft 200. Here, the flow body system 100 has multiple flow actuator modules 1, which are arranged between a leading edge 205 and a movable vertical rudder 206 which is situated opposite the leading edge 205. The aircraft 200 furthermore has the electrical voltage source V, which is symbolically illustrated in FIGS. 1, 2 and 7, and the switching device 201, by which the coils 30 of the flow actuator modules 1 are electrically connectable to the voltage source V.

During the takeoff and during the flight of the aircraft 200, the flow surface 2a of the vertical tail unit 202 is flowed over by a fluid flow in the flow direction F. Here, the flow actuator 20 of the flow actuator module 1 is situated in the retracted position, as shown by way of example in FIG. 1, and is, by the armature 35, fixed in the retracted position by action of an electrical current flow through the coil 30 on the support device 10. At the same time, it is detected whether a triggering criterion for the pivoting of the flow actuator 20 into the deployed state is present. The triggering criterion may be defined for example by an operating state of the engines 207 of the aircraft 200. The triggering criterion is present if one of the engines 207 fails or generates less thrust than the other engines. In this case, the current flow through the coil 30 is interrupted, and the flow actuator 20 is thus released or unlocked. Since the fluid flow flows over the flow surface 2a with a particular flow speed, a pressure difference exists between the interior space I of the flow body 2—in this case the vertical tail unit 202—and the surroundings, which pressure difference effects a pivoting of the flow actuator 20 into the deployed position, as illustrated by way of example in FIG. 2. As already discussed above, alternatively or subsequently to the interruption of the current flow through the coil 30, it is also possible for an alternating current flow to be generated through the coil 30, for example by a current converter 204 of the switching device 201, as shown by way of example in FIG. 7. In the deployed position of the flow actuators 20, these form a flow obstruction for the fluid flow and thus generate vortex structures, which impede the flow separation, in the fluid flow. In this way, a greater force can be transmitted from the fluid flow to the vertical rudder 206, and thus the asymmetrical thrust resulting from the engine failure can be compensated by the vertical rudder 206.

Even though the disclosure herein has been discussed above by way of example on the basis of exemplary embodiments, the disclosure herein is not restricted to these but rather may be modified in a wide variety of ways. In particular, combinations of the above exemplary embodiments are also conceivable.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE DESIGNATIONS

1 Flow actuator module
2 Flow body
2A Recess of the flow body
2a Flow surface of the flow body
2b Inner surface of the flow body
10 Support device
11 Base portion of the support device
11a First surface of the base portion
12 Frame portion of the support device
20 Flow actuator
21 Actuation portion of the flow actuator
21a First surface of the actuation portion
22 Flow plate of the flow actuator
22a First surface of the flow plate
22b Second surface of the flow plate
23 Periphery of the actuation portion
23A-23C Limbs of the periphery of the base portion
24 Periphery of the flow plate
24A First limb of the periphery of the flow plate
24B Second limb of the periphery of the flow plate
24C Third limb of the periphery of the flow plate
25 Connection plate
26 Stiffening rib
27 Cam
28 Recess
30 Electrical coil
35 Armature
40 Preload device
50 Return device
51 Drive
52 Actuation element
60 Base plate
60a Outer surface of the base plate
60b Inner surface of the base plate
60c Abutment region of the base plate
61 Recess of the base plate
61A First limb of the recess of the base plate
61B Second limb of the recess of the base plate
61C Third limb of the recess of the base plate
70 Rotary joint
71 First joint portion
72 Second joint portion
73 Bolt
75 Guide rail arrangement
76 First rail
77 Second rail
100 Flow body system
200 Aircraft
201 Switching device
202 Vertical tail unit
203 Switching element
204 Current converter
205 Leading edge
206 Vertical rudder
A Axis of rotation
F Flow direction of the fluid flow
I Interior space of the flow body
R21 Rear side of the actuation portion
R22 Rear side of the flow plate
V Voltage source
X Double arrow

1. A flow actuator module, having:
a support device;
a flow actuator mounted on the support device and movable between a retracted position and a deployed position and which has an actuation portion and a flow plate rigidly connected to the actuation portion;
an electrical coil on the support device; and
an armature on the actuation portion of the flow actuator and comprising a magnetizable metal material;
wherein the flow actuator, in the retracted position, is fixable in a positionally static manner relative to the support device by the armature by generation of an electrical current flow through the coil.

2. The flow actuator module of claim 15, wherein the actuation portion is of plate-like form and extends at an angle relative to the flow plate.

3. The flow actuator module of claim 2, wherein the actuation portion and the flow plate are connected by a connection plate which extends between them.

4. The flow actuator module of claim 1, wherein the flow actuator is mounted on the support device and pivotable about an axis of rotation, and wherein the axis of rotation is defined by a rotary bearing or by a guide rail arrangement.

5. The flow actuator module of claim 5, wherein the flow plate has a first surface for arrangement in alignment with a flow surface of a flow body in the retracted position of the flow actuator, and has a second surface situated opposite the first surface, wherein the second surface of the flow plate faces toward the actuation portion, and wherein the axis of rotation is on a rear side of the flow plate, the rear side being defined by the second surface of the flow plate.

6. The flow actuator module of claim 4, wherein the actuation portion has a first surface facing toward the flow plate, and wherein the axis of rotation is on a rear side of the actuation portion, the rear side being situated opposite the first surface of the actuation portion.

7. The flow actuator module of claim 1, wherein the flow plate is formed with a triangular periphery.

8. The flow actuator module of claim 1, additionally comprising a preload device between the support device and the flow actuator and which, in the retracted position of the flow actuator, preloads the latter relative to the support device in a direction of the deployed position.

9. The flow actuator module of claim 1, additionally comprising a return device coupled to the support device and which has a drive and an actuation element, wherein the actuation element is coupled to the flow actuator and movable relative to the support device by the drive.

10. The flow actuator module of claim 1, additionally comprising:
a base plate fastened to the support device and which has a recess, wherein, in the retracted position of the flow actuator, the flow plate is in the recess of the base plate and a first surface of the flow plate is in alignment with an outer surface of the base plate, and
wherein, in the deployed position of the flow actuator, the flow plate protrudes relative to the outer surface of the base plate.

11. The flow actuator module of claim 10, wherein the actuation portion of the flow actuator, in the deployed position, bears against an inner surface of the base plate, the inner surface being situated opposite the outer surface, and in so doing covers the recess of the base plate.

12. A flow body system for an aircraft, comprising:
a flow body with a flow surface for being flowed over by a fluid flow, and with an inner surface situated opposite the flow surface, wherein the flow body has a recess which extends between the flow surface and the inner surface; and
a flow actuator module, comprising:
a support device in an interior space of the flow body, the interior space being defined by the inner surface of the flow body;
a flow actuator mounted on the support device and movable between a retracted position and a deployed position and which has an actuation portion and a flow plate rigidly connected to the actuation portion, wherein, in the retracted position, the flow plate is in the recess of the flow body and a first surface of the flow plate is in alignment with the flow surface of the flow body, and wherein, in the deployed position, the flow plate protrudes relative to the flow surface of the flow body;
an electrical coil on the support device; and
an armature on the actuation portion of the flow actuator and which comprises a magnetizable metal material;
wherein the flow actuator, in the retracted position, is fixable in a positionally static manner relative to the support device by the armature by generation of an electrical current flow through the coil.

13. An aircraft comprising a flow body system that comprises:
a flow body with a flow surface for being flowed over by a fluid flow, and with an inner surface situated opposite the flow surface, wherein the flow body has a recess which extends between the flow surface and the inner surface; and
a flow actuator module, comprising:
a support device in an interior space of the flow body, the interior space being defined by the inner surface of the flow body;
a flow actuator mounted on the support device and movable between a retracted position and a deployed position and which has an actuation portion and a flow plate rigidly connected to the actuation portion, wherein, in the retracted position, the flow plate is in the recess of the flow body and a first surface of the flow plate is in alignment with the flow surface of the flow body, and wherein, in the deployed position, the flow plate protrudes relative to the flow surface of the flow body;
an electrical coil on the support device; and
an armature on the actuation portion of the flow actuator and which comprises a magnetizable metal material;
wherein the flow actuator, in the retracted position, is fixable in a positionally static manner relative to the support device by the armature by generation of an electrical current flow through the coil; and
an electrical voltage source which is electrically connectable by a switching device to the coil of the flow actuator module.

14. The aircraft of claim 13, wherein the flow body of the flow body system is formed by a vertical tail unit of the aircraft.

15. The aircraft of claim 13, wherein the switching device has a current converter for applying an alternating current to the coil.
